(19) United States
(12) Patent Application Publication
(10) Pub. No.: US 2014/0006176 A1
(43) Pub. Date: Jan. 2, 2014

(54) METHOD AND SYSTEM FOR SCORING THE INFLUENCE OF A SENDER OF CONTENT

(71) Applicants: Bhaskar R. Gudlavenkatasiva, Tampa, FL (US); Nityanand Sharma, Tampa, FL (US); Premanand Sivakkolundhu, Tampa, FL (US)

(72) Inventors: Bhaskar R. Gudlavenkatasiva, Tampa, FL (US); Nityanand Sharma, Tampa, FL (US); Premanand Sivakkolundhu, Tampa, FL (US)

(73) Assignee: Verizon Patent and Licensing Inc., Basking Ridge (US)

(21) Appl. No.: 13/538,635

(22) Filed: Jun. 29, 2012

(51) Int. Cl. G06Q 30/02

(52) U.S. Cl. 705/14.73

(57) ABSTRACT

An approach for scoring the influence of a user based on the sharing of an advertisement by the user with others is described. An advertising sharing platform determines a forwarding of an advertisement by a first device to a second device associated with a social network of a user of the first device. The advertising sharing platform then generates an influence score of the user of the first device and the user of the second device based on the type of response based on a determined type of response of the user.

### BACKGROUND INFORMATION

Service providers are continually challenged to deliver value and convenience to consumers by providing compelling network services and advancing the underlying technologies. One area of interest has been the development of services and technologies for sharing of content between device users, including advertisement content. Many advertisers recognize the significant value of combining advertisement content with social networking. By way of example, advertisers may direct targeted advertisements and offers to groups of people (consumers) based on their common interests and affiliations. Unfortunately, advertisers are limited in their ability to track and subsequently determine the influence of a user when they share an advertisement with their personal contacts.

Based on the foregoing, there is a need for an approach to more effectively provide advertisement services.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system for scoring the influence of a user based on the sharing of an advertisement by the user with others, according to one embodiment;

FIG. 2A is a diagram of a advertising sharing platform, according to one embodiment;

FIG. 2B is a diagram of a use case for determining an influence score of a user based on the sharing of an advertisement by the user with others, according to one embodiment;

FIGS. 3A-3C are flowcharts of processes for scoring the influence of a user based on the sharing of an advertisement by the user with others, according to various embodiments;

FIGS. 4A-4D are diagrams of user interfaces for enabling sharing of advertisement content with others, according to various embodiments;

FIG. 4E is a diagram of a user interface for enabling an advertisement provider to monitor the influence of a user that shares advertisement content with others, according to one embodiment;

FIG. 5 is a diagram of a computer system that can be used to implement various exemplary embodiments; and

FIG. 6 is a diagram of a chip set that can be used to implement an embodiment of the invention.

### DESCRIPTION OF THE PREFERRED EMBODIMENT

An apparatus, method and software for scoring the influence of a user based on the sharing of an advertisement by the user with others are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to advertisements, it is contemplated that these embodiments have applicability to content and media of various types. This may include, for example, commercials, web based media, notification messages, polls, instruction sets and the like. As will be discussed more fully herein, the advertisements may be generated by one or more third party advertisement providers for use in connection with an advertisement sharing scheme. Also, while various exemplary embodiments are described with respect to a social network, it is contemplated these embodiments have applicability to any local, shared or network based medium for storing contact information for one or more persons.

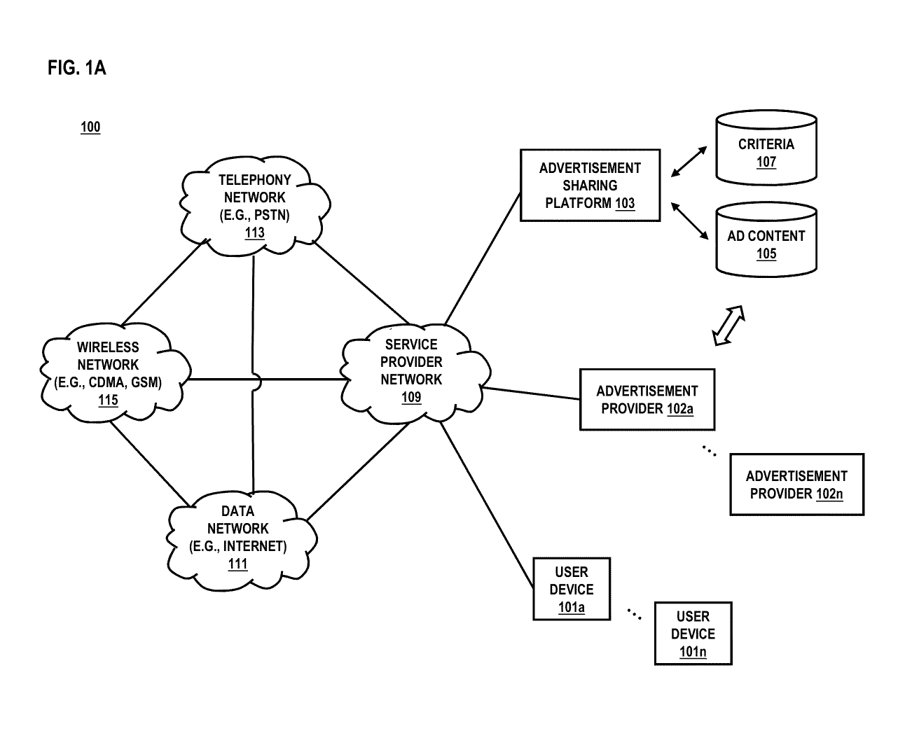

FIG. 1 is a diagram of a system for scoring the influence of a user based on the sharing of an advertisement by the user with others, according to one embodiment. The system 100 includes an advertisement sharing platform 103 that is configured to enable the forwarding of advertisement content 105 by one or more users of user devices 101a-101n (e.g., a mobile device, smart phone, netbook, tablet, laptop, set-top box, television). For the purpose of explanation, the one or more user devices 101a-101n (referred to collectively herein as user devices 101) may be implemented as any communications enabled device for interacting with the advertisement sharing platform 103 via a network (e.g., service provider network 109).

The advertisement content 105 may be generated or distributed by one or more third party advertisement providers 102a-102n, referred to herein collectively as advertisement providers 102. The advertisement providers may include, for example, various retailers, merchants, product manufacturers, marketing agents, distribution or sales channels, vendors, etc. Still further, the advertisement providers 102 may also include one or more research groups or other agencies that may have an interest in consumer/user behavioral information. It is noted, therefore, that the advertisement providers 102 may be directly or indirectly associated with the advertisement content and/or the product or service that is the subject of the advertisement.

As mentioned previously, many retailers, vendors and service providers recognize the impact of social networking on the marketing and advertising process. For example, some retailers will direct targeted advertisements and offers to individuals or groups based on their determined interests and online interaction patterns. Under this approach, for example, if peers within the social network communicate regularly about video games, the social networking interface may be configured to present more advertisements by video game retailers and vendors. As yet another approach, retailers and vendors may also develop schemes for inviting commentary, feedback and recommendations regarding their products to be shared among the group, thereby leveraging the influence of the peers within the social network or generating a word-of-mouth campaign.

Currently, attempts at target marketing, viral advertising promotion or word-of-mouth (shared) marketing do not support determining the level of influence of users. In particular, no mechanism exists whereby the influence determination is based on various criteria. For example, key criteria for gauging the effectiveness of an opinion poll may be based on the number of individuals who respond to a survey while the criteria for a computer product advertisement may be based on the number of purchases placed. Unfortunately, many advertisement providers 102 are limited in their ability to selectively define and customize such criteria in relation to a shared marketing campaign. Still further, advertisement providers 102 have limited ability to determine the influence of a given user based on persistent tracking of a shared advertisement as it is forwarded to others.

To address this issue, system 100 of FIG. 1 enables users of devices 101a-101n, such as set-top boxes and smartphones, to share advertisement content 105 with others. By way of example, the advertisement sharing platform 103 enables advertisement content 105 to be initially directed to select user devices 101. This same advertisement content is then able to be forwarded by the same user to others. Under this scenario, the advertisement sharing platform 103 may direct advertisement content 105 pertaining to a product of retailer A to a user of a first user device 101a. Upon receipt, the user executes various actions, including reviewing the advertisement, deleting the advertisement, completing a purchase action, completing a registration procedure, etc. In addition, the advertisement sharing platform 103 may also enable the user to distribute (e.g., forward) the advertisement content 105 to others. Forwarding may be facilitated by way of one or more data tagging techniques—i.e., to enable persistent monitoring of the sequence and depth of distribution of advertisement content 105 among user devices 101.

By way of example, advertisement content 105 (e.g., initially sent or subsequently forwarded) is presented to a display of a user device 101. The advertisement content 105 may be presented by way of a dedicated application at the device, a web browser, or through an application programming interfaces (APIs). Also, the advertisement sharing platform 103 presents the advertisement content 105 in connection with various user selection options. The selection options may be rendered to the display as one or more user interface elements, i.e., action buttons, menus, data entry fields, etc., for receiving user input. Selection of an action button may indicate a type of response of the user to the advertisement. Hence, the selection is provided as input to the advertisement sharing platform 103 for correlating the response with a specific (desired) user response action.

In certain embodiments, the advertisement sharing platform 103 enables correlation of a user provided input with a type of response based on response criteria 107 established by the advertisement providers 102. The response criteria 107 define the input types to be received for determining a response of the user to the advertisement content 105. For example, selection of a “BUY” action button presented in connection with advertisement content 105 may be correlated with a purchase action as defined by the advertisement provider 102. As another example, selection of the “SAVE” action button by the user may be correlated with a pending review action of the user as defined by the advertisement provider. Still further, selection of a “PLAY” action button may be correlated with a review action of the user, such as in the case of a media based advertisement content 105. In the latter scenario, the amount of time of viewing and number of times of playback of the content 105 may be tracked by the advertisement sharing platform 103 for further determining a user response.

In addition to correlating an input to a defined action associated with the advertisement content, the criteria 105 also defines a value (e.g., numeric) of each response type. The numeric value may correspond to a level, ranking or priority of a given action. For example, a higher or lesser value may be assigned for one response type versus another relative depending on the advertisement. Under this scenario, a buy/purchase response may be valued higher than a “not interested” response of the user to specific advertisement content 105. Still further, in the case of advertisement content 105 pertaining to an upcoming event, a registration response action may be valued higher than a request for additional information. Hence, the criteria 107 may be used to define a relevancy, priority, etc., of a user response for deriving a level of influence of the user with respect to the content 105.

The value assigned to a determined user response action is also established by the advertisement provider 102. It is contemplated, however, that the value may be assigned by the advertisement sharing platform 103 based on a fixed value table or normalization scheme. Under this scenario, an equivalency is established for various different response types to account for differences in the nature, requirements or objectives of advertisements. Hence, a buy/purchase response for a first advertisement may be assigned an equivalent value as a call response for a second advertisement. The advertisement sharing platform 103 may be configured to account for various different equivalencies and scenarios.

As mentioned, the nature, requirements or objectives of different advertisement content 105 may vary. Consequently, the user interface elements presented with the advertisement content 105 may be customized accordingly. Hence, the user interface elements may be associated with one or more variables/factors of a coordinated campaign strategy, marketing strategy or the like. In certain embodiments, the advertisement provider 102 may access the advertisement sharing platform 103 via the network 109 through a configuration interface; such as to establish the response criteria 107 (e.g., define the variables/factors) accordingly. Under this scenario, the criteria 107 may be stored as a unique data file for retrieval by the advertisement sharing platform 103 in connection with specific advertisement content 105. The advertisement content 105 may include a reference/pointer to a corresponding data file.

In certain embodiments, the advertisement sharing platform 103 calculates an influence score of a user based on their response to advertisement content 105. By way of example, the influence score is calculated via a scoring scheme/algorithm, wherein the scheme/algorithm is a function of the determined user inputs and/or correlated response actions. Still further, the scoring scheme/algorithm may be based on function of various data collected as a result of transmission (forwarding) of advertisement content 105 to others. The statistics may be compiled as a collection of data for indicating the types of responses of at least one user and multiple other users to whom the advertisement content 105 was forwarded.

By way of example, the statistics may include a number of times the advertisement content 105 was forwarded, a number of views of the advertisement content 105, a number of purchase transactions conducted per the advertisement content 105, an amount of separation/propagation/depth of the advertisement content 105 from the forwarding user, the extent of commonality between various recipients of the advertisement content 105, historical attributes associated with a recipient of the advertisement content 105, a level of affinity of the user with a specific demographic and/or matching interests corresponding to the product for which the advertisement content 105 pertains.

Of note, the influence score enables the advertisement sharing platform 103 to rank and categorize the influence a user exerts directly and indirectly on other recipients of the same advertisement content 105. In certain embodiments, the calculated score may then be stored and/or subsequently transferred to the advertisement provider 102. In addition, the influence score may be compiled in connection with the various statistics into a report to be reviewed by the corresponding advertisement provider 102. By way of example, the influence score and corresponding report may be stored in a cloud based server, hosted server or the like. Still further, the influence score and corresponding statistics report may be transferred to the advertisement provider 102 via a network connection (e.g., service provider network 109) or by way of an application programming interface (API). Of note, the influence score and associated report may be associated with profile information maintained for a corresponding user.

In certain embodiments, the advertisement provider 102 may access the influence score and corresponding statistics through a reporting interface of the advertisement sharing platform 103. By way of the reporting interface, the advertisement provider 105 may review the statistics as well as generate additional analysis of the data for further investigating the response of the user and others to the advertisement content 105. Still further, by way of the reporting interface, the advertisement provider 102 may customize the level of granularity of the report. For example, the report may be presented at the level of an individual that forwarded the advertisement to others, at a group or demographic level, by location, by advertisement campaign, by level of influence, etc.

The data compiled by the advertisement sharing platform 103 in connection with specific user influence ranking may be employed by the advertisement service provider 102 to support various marketing, research, product development and customer service activities. For example, in one scenario, the advertisement provider 102 may utilize the influence score and associated statistics of user A with influence score X to anticipate additional purchases of similar products from others within user A's social network. Under this scenario, the advertisement provider 102 may further customize additional purchase recommendations, coupons and user incentives into target categories (e.g., high, medium and low likelihood of purchase) based on the customer A's influence score. Still further, the advertisement provider 102 may assess the feasibility of a new product or viability of a marketing campaign based on the determined response type (e.g., behavior) of user A and those within user A's network.

In another scenario, the advertisement provider 102 may determine a product associated with certain advertisement content 105 will be returned based on the return of other users with influence score X. A propensity of returns by users with high influence scores enables the advertisement provider to anticipate additional returns of similar products from other customers within the social network, i.e., based on the influence of such users, typical group response types (behaviors), etc.

In another scenario, the influence score can be used as criteria for performing call center and/or customer service operations. Under this scenario, for example, users with high influence scores may be directed to high priority service representatives while lower influence users may be directed to standard priority service representatives. Under this scenario, the call center and/or customer service providers and advertisement providers may allocate business resources based on awareness of the impact of a positive or negative experience of a user with a high level of influence.

In one embodiment, the influence score and associated report for a given user may also be presented to the user. By way of example, the user may access the activity sharing platform 103 via a user reviewing interface for reviewing their influence score, the results of one or more forwarded advertisements, etc. In addition, the user may be presented with various user interface elements for enabling further sharing of advertisement content 105 with individuals within their social network (e.g., an online or local contact database).

The data compiled by the advertisement sharing platform 103 in connection with specific user influence ranking may be employed by the user to support various consumer transactions, social interactions and product inquiries. For example, in one scenario, the influence score of a user can be used as criteria for automatically initiating a purchase transaction or incentive of a retailer. Under this scenario, a user of a location based service may automatically transmit their credentials, i.e., via near-field communications, to a point-of-sales terminal having radio frequency identification (RFID) tags or other sensors. The user's credentials (including influence score) may be initiated for transfer due to tagging or touching of the RFID tag with the user device.

In another scenario, the user may be presented with incentive information (e.g., coupons), additional advertisement or purchase recommendations and other data related to their influence score.

Still further, the influence score information may be used to activate special features of a product or service associated with an advertisement forwarded by the user. Under this scenario, the special feature is activated during initial registration and/or activation of the associated product. Alternatively, the special feature may be automatically configured, with progressively more features being activated, based on real-time updating of an influence score of the user in connection with advertisement content 105.

In certain embodiments, user devices 101, the advertisement sharing platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions.

According to exemplary embodiments, one or more of the user devices 101a-101n may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smartphone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

The advertisement sharing platform 103 can interact with any of user devices 101 to generate an influence score based on the sharing of advertisement content. Exemplary components of platform 103, according to one embodiment, are described below.

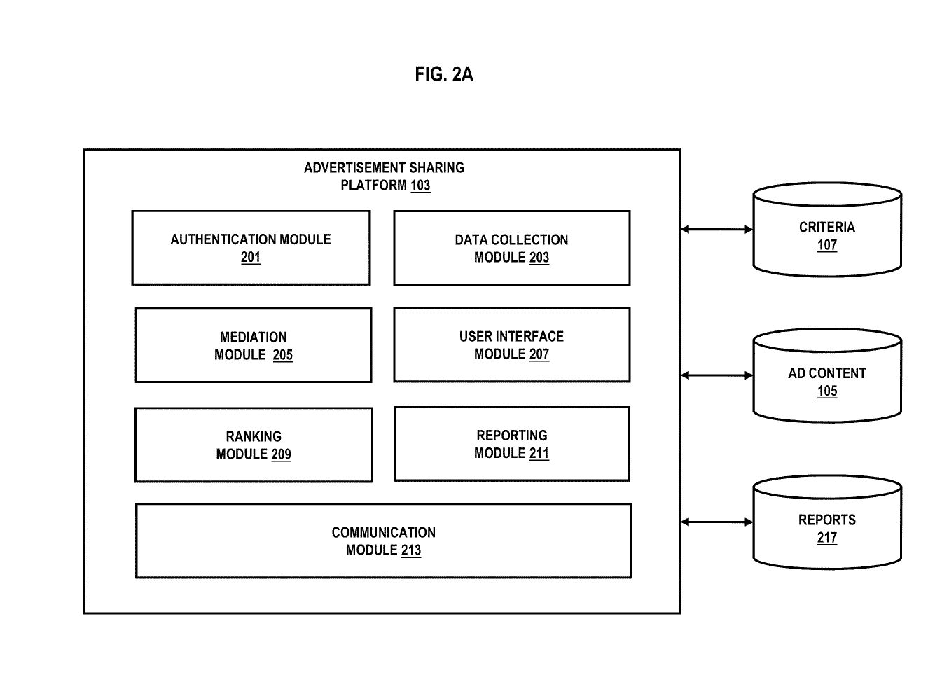

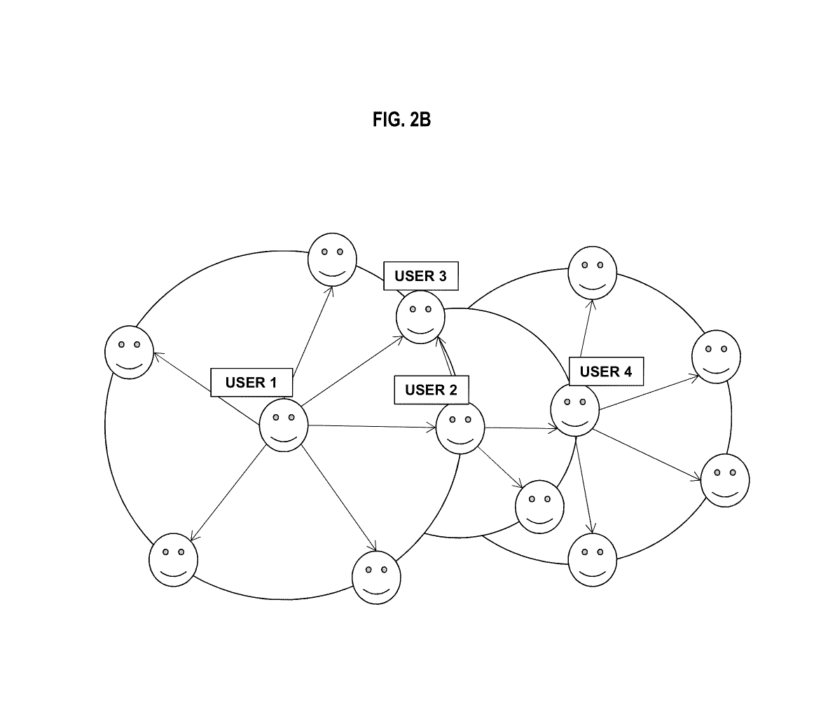

FIG. 2 is a diagram of an advertisement sharing platform, according to one embodiment. The advertisement sharing platform 103 includes various executable modules for performing one or more computing, data processing and network based instructions that in combination provide a means of scoring the influence of a user based on the sharing of an advertisement by the user with others. Such modules can be implemented in hardware, firmware, software, or a combination thereof. By way of example, the advertisement sharing platform 103 may include an authentication module 201, a data collection module 203, a mediation module 205, a user interface module 207, a ranking module 209, a reporting module 211 and a communication module 213.

In addition, the advertisement sharing platform 103 also maintains advertisement content 105 as received from various advertisement providers 102 (e.g., a retailer/vendor), response criteria 107 pertaining to the various response input types of a viewer of advertisement content 105 and statistical reports 217 pertaining to various viewers of advertisement content. The various modules 201-215 of the advertisement sharing platform 103 may access databases 105 for performing is various executable functions.

In one embodiment, an authentication module 201 authenticates users and user devices 101a-101n for interaction with the advertisement sharing platform 103. By way of example, the authentication module 201 receives a request from a user of a device 101 to subscribe to the advertisement content sharing service for enabling scoring of the user's influence. The subscription process may include establishing various preferred influence score and statistics viewing settings. In addition, the user may also indicate one or more preferences regarding their interests for supporting receipt of targeted advertisements. For example, the user may indicate a preference for vehicle or clothing related advertisements. The preferences and settings of the user may be stored in connection with profile information pertaining to the user. Of note, in certain instances, the initial authentication process may also involve the activation and/or downloading of an application (not shown) for viewing advertisements via the user device 101.

Similarly, one or more advertisement providers 102 may also subscribe with the advertisement sharing platform 103 for enabling accessing of user specific influence scores and advertisement sharing statistics. The subscription may include specifying the location of advertisement content 105 to be directed to users. In addition, the subscription process may include establishing settings for customizing statistical reports generated for various users. Still further, the advertisement provider 105 may also specify criteria 107 for processing/interpreting the types of responses of a user to advertisement content 105

It is noted that for users and advertisement providers, the authentication module 201 enables the subscription procedure to be performed based on various subscription models. For example, in the case of a paid subscription model, the authentication module 201 may coordinate with a payment processing service to enable paid access to influence scores, user profile information and related statistical reports. As another example, the authentication module 201 may further access a cloud based service for enabling seamless storing of various data sets (e.g., databases 107, 105 and 217). Under this scenario, the authentication module 201 facilitates a login and data sharing procedure via a cloud computing access protocol.

The authentication process performed by the module 201 may also include receiving and validating a login name and/or user identification value provided or established during subscription. The login name and/or user identification value may be received as input from the user device 101 or other device via a graphical user interface to the platform 103 (e.g., as enabled by user interface module 215). Alternatively, the login procedure may be performed through automated association of profile information with an identification signal generated by an active device, i.e., a carrier detection signal.

In one embodiment, the mediator module 203 operates in connection with the authentication module 201 to access advertisement content 105. This may include, for example, initiating accessing of updated advertisement content from the advertisement provider for storage to a database 105. Also, the data collection module 205 also facilitates retrieval of advertisement content 105 in response to a request, i.e., from a user or advertisement provider, for accessing or forwarding the content. As such, the mediation module 205 serves as a gateway for enabling sharing of advertisement content by one or more subscribed users of the platform 103.

In addition, the mediation module 205 determines a correlation between an input provided by a user in association with advertisement content 105 and a defined type of response of the user. Under this scenario, the mediation module 205 accesses response criteria 107 for enabling the correlation and subsequently initiates activation of a ranking module 203 for generating an influence score for the user. In one embodiment, the ranking module 209 determines a numeric value to associate with the determined response of the user based on the criteria 107.

Still further, the mediation module 205 also operates in connection with the ranking module 209 to cross reference various users within a social network to minimize redundancies. This includes accounting for duplicate contacts, user affiliations and the like that may affect the influence score attributed to one or more users in connection with advertisement content 105. For example, in the case where a single user is associated with multiple different email addresses or contact numbers, the mediation module 205 determines such redundancies based on the profile information, email address lookup, contact management database analysis, etc.

The data collection module 203 also maintains, in connection with a reporting module 211, data for tracking the types of response of a user to advertisement content 105. For example, the data collection module 203 may collect and store statistics associated with the viewing of advertisement content by a user, including an amount of time of viewing of advertisement content, a number of times of viewing of advertisement content, a number of advertisement content recommendations, social networking profile based recommendations, etc.

In one embodiment, the user interface module 207 facilitates generation of various interfaces for enabling users and advertisement providers to interact with the advertisement sharing platform 103. This includes, for example, generation of a configuration interface for enabling advertisement providers to input and/or define response criteria 107. In addition, the user interface module 207 operates in connection with a reporting module 211 to generate a reporting interface for enabling accessing of statistics reports and an influence score of a user. The reporting module 211 receives statistics pertaining to the user response to an advertisement from the data collection module 203. It then compiles the data into a report based on the defined preferences and settings of the user via the authentication module 201.

Still further, the user interface module 207 may cause generation of a user interface for enabling users subscribed to the platform 103 to view their influence score along with various statistics regarding advertisement content they forwarded. In addition, the user interface module 207 generates various user interface elements, such as action buttons, for receiving input from the user in connection with the advertisement content 105. By way of example, the user interface module 207 generates the user interface and various elements thereof in response to application programming interfaces (APIs) or other function calls.

In one embodiment, the ranking module 209 calculates an influence score of a given user in connection with advertisement content 105. By way of example, the ranking module 209 employs various scoring algorithms/schemes that are based on one or more input variables, including those corresponding to a response type of the user to an advertisement. An exemplary scheme/algorithm is shown below:

Vᵢₛ=R₁*C_{f1}+R₂*C_{f2}+ . . . +Rₙ*C_{fn},
where C_{fn}=1+I_{f}*(n−1)

By way of example, the input variables are as follows:
n=a number representing a level of depth to which the advertisement content has been forwarded
Rₙ=a number of people that watched the advertisement content at nth level;
C_{fn}=a coefficient of influence at nth level; and
I_{f}=an influence factor, which corresponds to a numeric value for a certain type of user response.

In this scheme, the influence score accounts for various types of user responses at multiple levels of propagation/depth of the advertisement content 105. FIG. 2B presents an exemplary use case depicting calculation of an influence score via this scheme. For the purpose of illustration, the influence factor is tabulated at 0.2, corresponding to that determined via correlation of the user provided input with the response criteria 105.

By way of example, a user of a first device (e.g., smartphone or set-top-box) labeled USER 1 forwards advertisement content to six members of their social network. One of USER 1's contacts, labeled USER 2, receives then subsequently forwards the same advertisement content to three others within their social network, including a user labeled USER 3. In this case, USER 3 is common to both USER 1 and USER 2. One of USER 2's contacts, labeled USER 4, further forwards the advertisement content to four others within their social network.

The level of depth/propagation of the advertisement content is a total of three levels. Also, because USER 3 is a common contact, data related to USER 3 is used to compute USER l's influence score but not USER 2's. Hence, the algorithm/scheme accounts for redundancies accordingly. Based on the above, the resulting calculation of USER 1's influence score is as follows:

C_{f1}=1+0.2*(1−1)=1, where R₁=6

C_{f1}=1+0.2*(2−1)=1.2, where R₂=2

C_{f1}=1+0.2*(3−1)=1.4, where R₃=4,

therefore,

Vᵢₛ=6*1+2*1.2+4*1.4=6+2.4+5.6=14

It is noted that the algorithm/scheme may be based on various other models. This may include, for example, a node based model wherein the calculation of the influence score is based on the sum total of viewers and/or purchasers of a product/service associated with advertisement content 105. Alternatively, a level based model may be employed wherein the calculation of the influence score is based on the depth of propagation of the advertisement content 105. Still further, a weight based model may be employed wherein the calculation of the influence score is based on a weight factor associated with various depths of propagation of the advertisement content 105.

The above presented modules 201-213 and components of the advertisement sharing platform 103 can be implemented in hardware, firmware, software, or a combination thereof. Though depicted as a separate entity in FIG. 1, it is contemplated that the advertisement sharing platform 103 may be implemented for direct operation by respective user devices 101. As such, the platform 103 generates direct signal inputs by way of the operating system of the device for interacting with the user interfaces generated via module 207. In another embodiment, one or more of the modules 201-213 may be implemented for operation as a platform 103 maintained as a hosted solution.

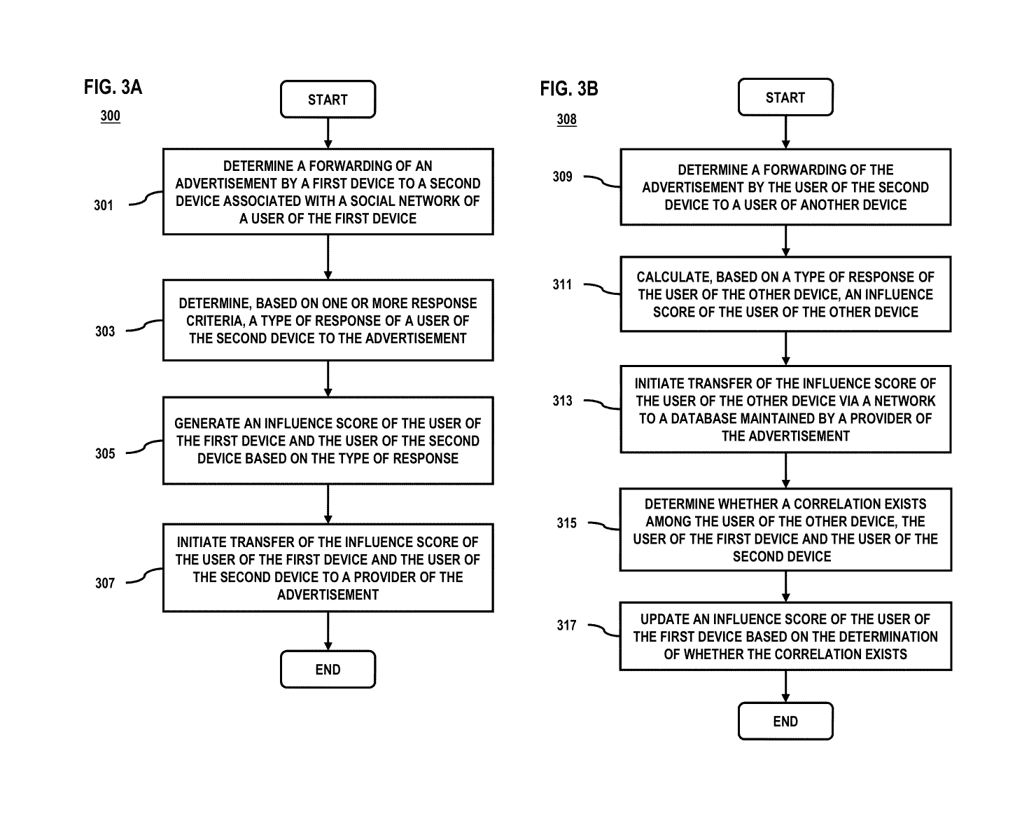

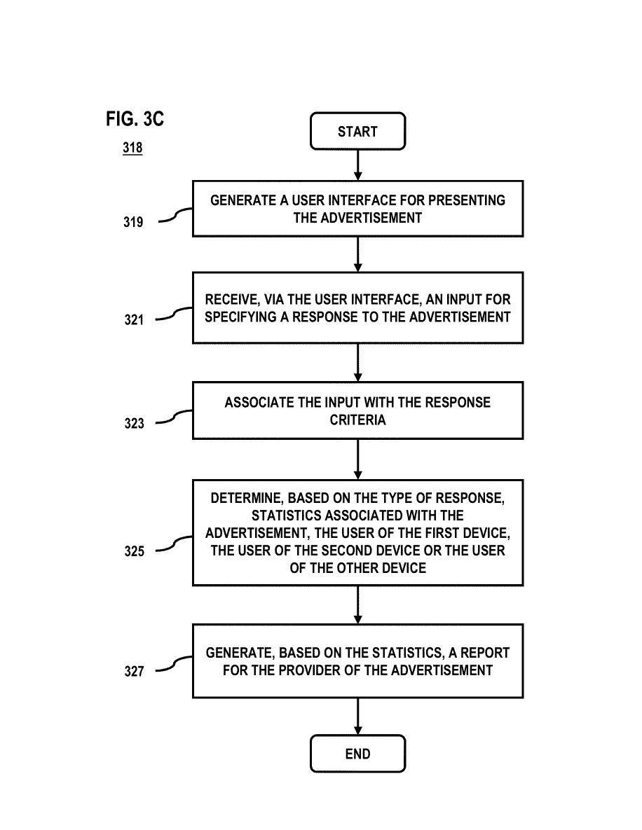

FIGS. 3A-3D are flowcharts of processes for scoring the influence of a user based on the sharing of an advertisement by the user with others, according to various embodiments. For the purpose of illustration, the processes are described with respect to FIG. 1. It is noted that the steps of the process may be performed in any suitable order, as well as combined or separated in any suitable manner.

In step 301 of process 300, the advertisement sharing platform 103 determines a forwarding of an advertisement by a first device to a second device associated with a social network of a user of the first device. In another step 303, the platform 103 determines, based on one or more response criteria, a type of response of a user of the second device to the advertisement. As noted previously, the response criteria may be defined by the advertisement provider to enable processing of user input provided to the user interface.

In step 305, the advertisement sharing platform 103 generates an influence score of the user of the first device and the user of the second device based on the type of response. The influence score may be calculated based on variables such as the depth of propagation of advertisement content, the number of times of forwarding of the message, etc. Per step 307, the platform 103 initiates transfer of the influence score of the user of the first device and the user of the second device to a provider of the advertisement.

In step 309 of process 308 (FIG. 3B), the advertisement sharing platform 309 determines a forwarding of the advertisement by the user of the second device to a user of another device. In step 311, the platform 103 calculates, based on a type of response of the user of the other device, an influence score of the user of the other device. As noted previously, the type of response may be correlated with a value of a variable of an algorithm/scheme for computing the score. In step 313, the platform 103 initiates transfer of the influence score of the user of the other device via a network to a database maintained by a provider of the advertisement. It is noted that the transfer may be performed via a data network or facilitated by way of an application programming interface to a system (e.g., cloud based server).

In step 315, the advertisement sharing platform 103 determines whether a correlation exists among the user of the other device, the user of the first device and the user of the second device. In step 317, the platform 103 updates an influence score of the user of the first device based on the determination of whether the correlation exists. The update is performed to ensure maximum accuracy of the influence score of a given user, i.e., no overlapping of contacts within a common social network of users to whom advertisement content was shared.

In FIG. 3C, the advertisement sharing platform 103 generates a user interface for presenting the advertisement. Per step 321, the platform 103 receives, via the user interface, an input for specifying a response to the advertisement. The input may be provided by way of various user interface elements, such as action buttons or data entry fields. By way of example, the user elements may be presented to the user interface for indicating a response action or type of the user (e.g., “BUY” or “EXIT”). Consequently, the response criteria and the input as received may be associated with either a purchase action, a forwarding action, a reviewing action, a bookmarking action, a storing action, a commenting action, a ranking action, an inquiry action of a user, or a combination thereof.

In another step 323, the platform 103 associates the input with the response criteria. Per step 325, the platform 103 determines, based on the type of response, statistics associated with the advertisement, the user of the first device, the user of the second device or the user of the other device. In step 327, the platform 103 generates, based on the statistics, a report for the provider of the advertisement. By way of example, the report may be customized by a user of a device that forwards the content or by an advertisement provider.

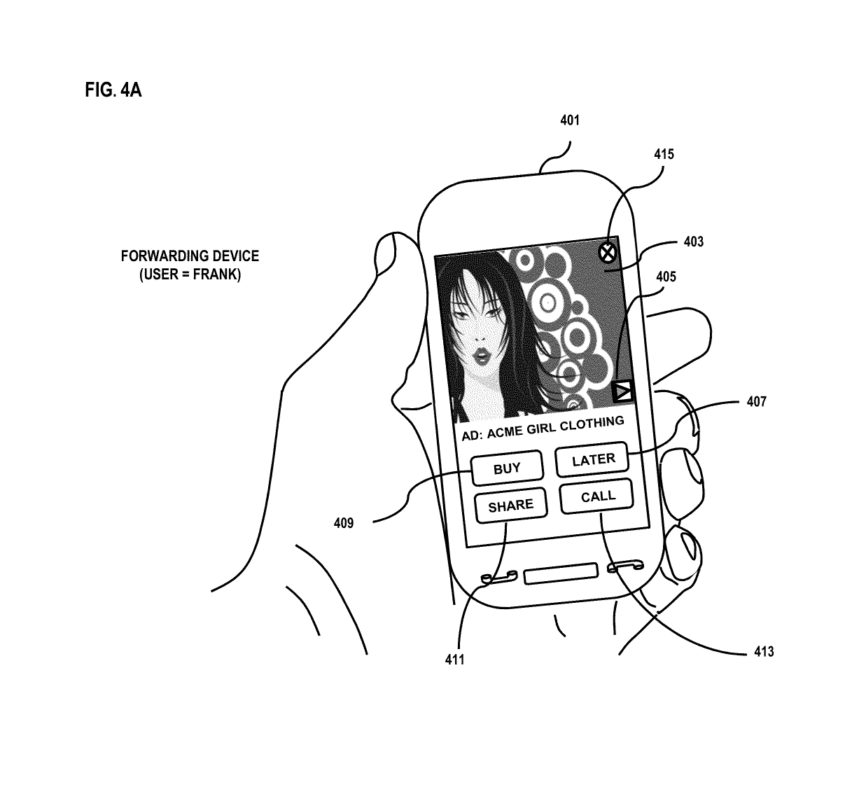

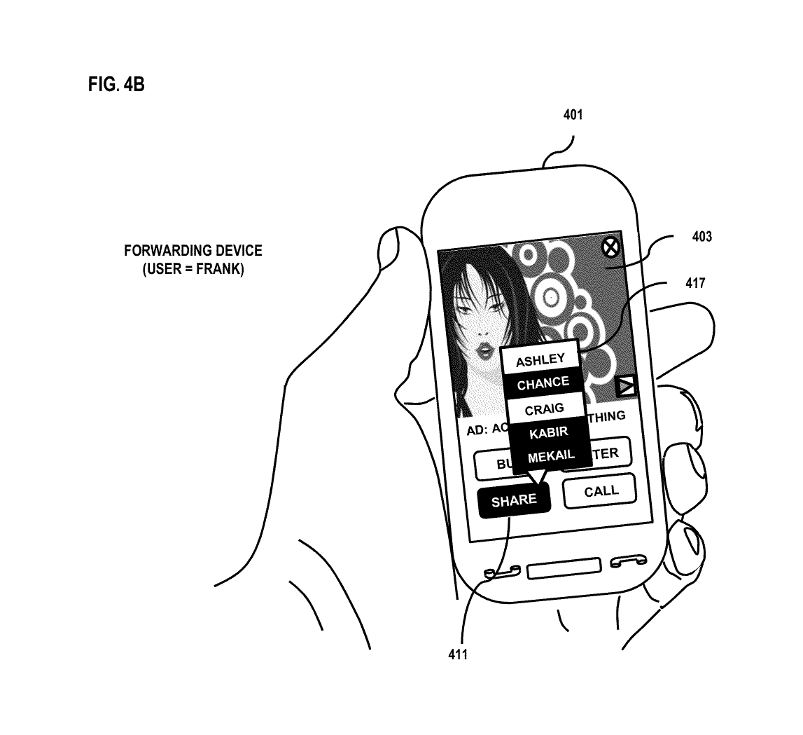

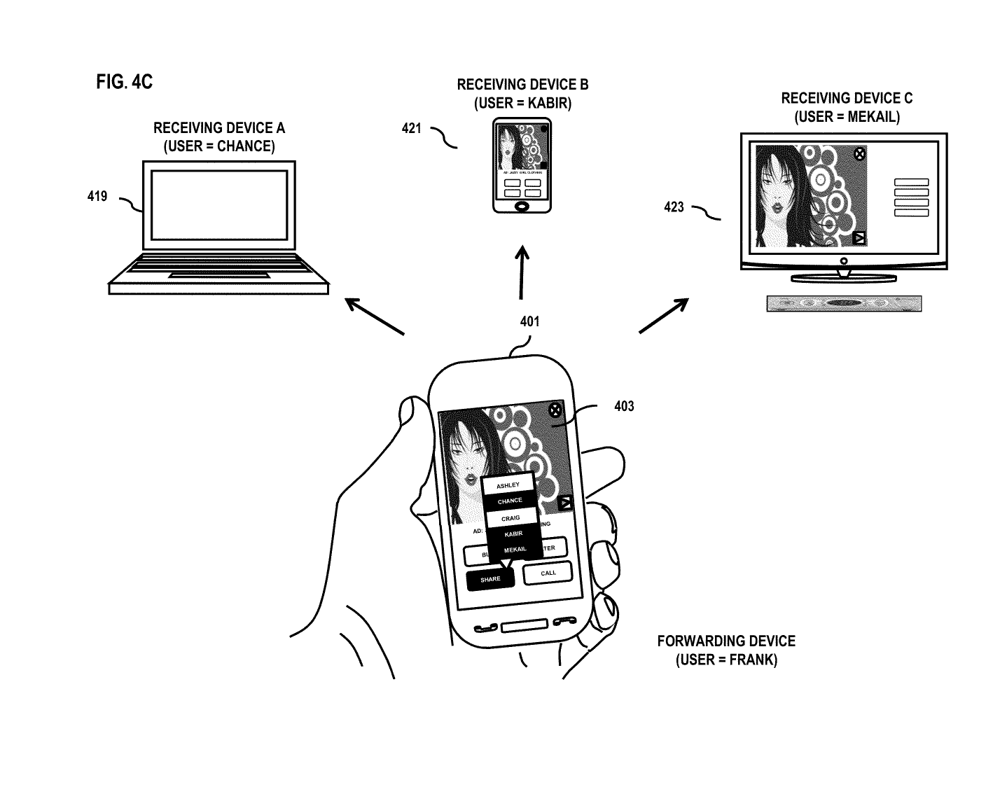

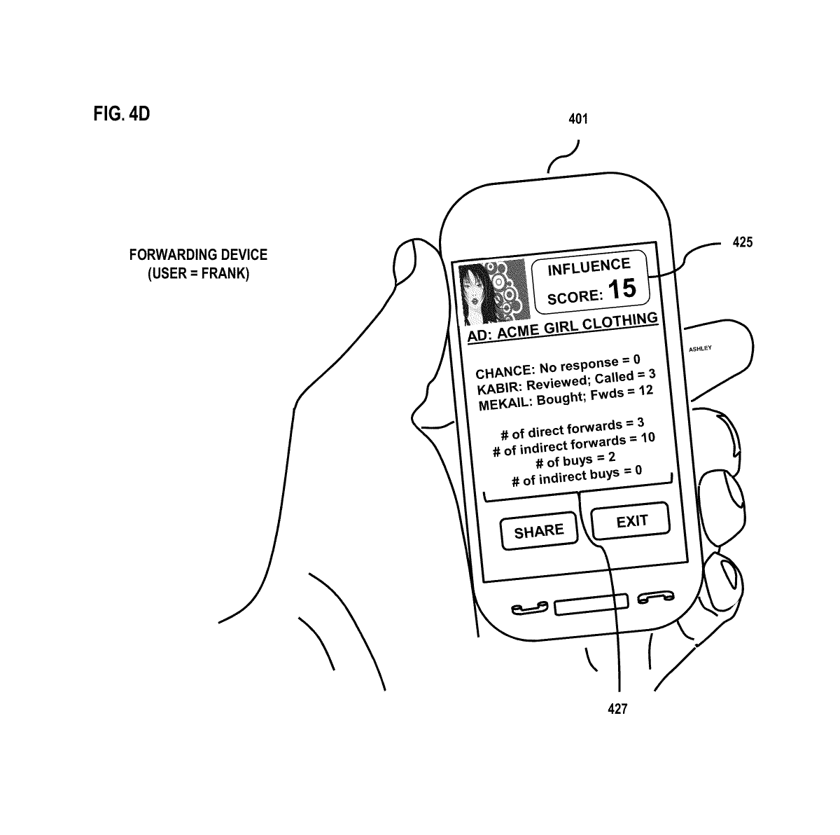

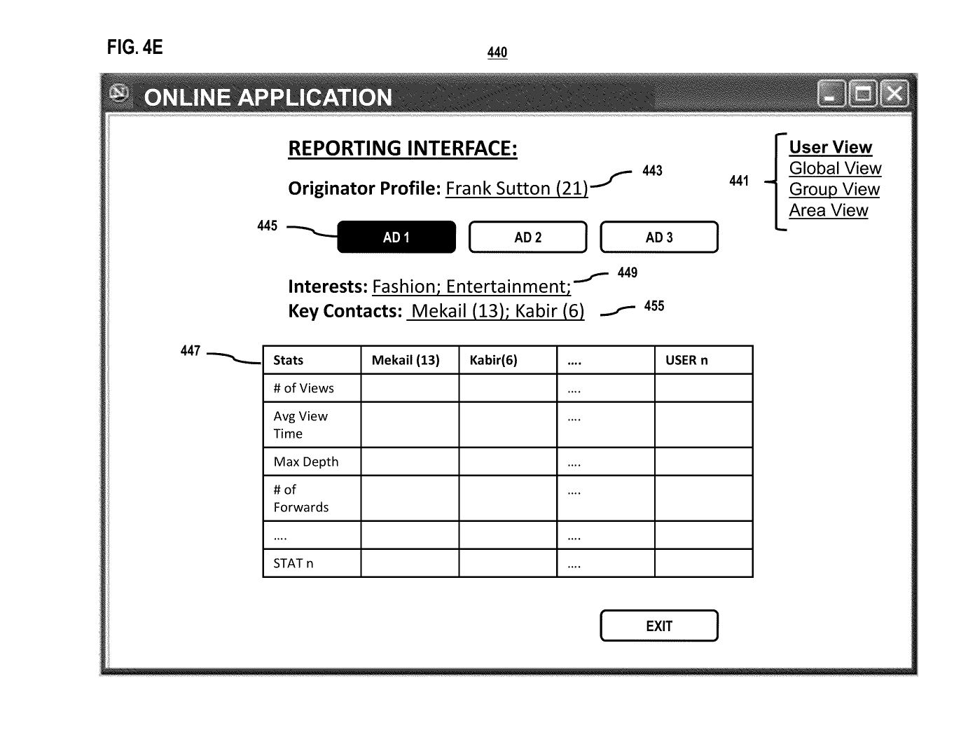

FIGS. 4A-4D are diagrams of user interfaces for enabling sharing of advertisement content with others, according to various embodiments. For the purpose of illustration, the diagrams are described with respect to an exemplary use case of a user forwarding a media advertisement to various members of their social network. Moreover, the diagrams are described from the perspective of one or more of the exemplary influence score algorithms/schemes described above (e.g., with respect to FIG. 2B). It is noted that while the user interface depictions correspond to the process of advertisement sharing, the devices may be configured to cause presentment of various additional screens based on interaction of devices with the advertisement sharing platform 103.

In FIG. 4A, a user of a device 401, referred to as a forwarding device, receives a media advertisement from the advertisement sharing platform 103. By way of example, the advertisement 403 corresponds to a commercial for ACME Girl Clothing, a woman's clothing and apparel provider. Under this scenario, the user reviews the commercial by selecting a PLAY action button 405. The user is also presented with various additional user elements for receiving a user input, including a BUY action button 409 for initiating a purchase of a product associated with the advertisement 403, a LATER action button 407 for enabling the user to review the advertisement 403 at a later time, a SHARE action button 411 for enabling the user to forward the advertisement 403 and a CALL action button 413 for initiating a call to the clothing and apparel provider.

As in the case of the PLAY action button 405 or CANCEL action button 415, any action taken by the user based on the advertisement 403 may be correlated with a response type. The response type may be defined per the criteria established by the advertisement provider in connection with the advertisement 403. Of note, the influence score of the user is updated based on the determined response type.

In FIG. 4B, a menu 417 for displaying various contacts within a social network of the user is presented. The menu 417 is activated in response to user selection of the SHARE action button 411. Under this scenario, the user is presented with the names of five contacts (e.g., friends), three of which the user highlights via the menu 417 for selection. Highlighting of the contacts indicates a forwarding response of the user, which is further correlated with associated response criteria and used to further update the influence score of the user.

As shown in FIG. 4C, the advertisement 403 is transmitted via a network to the user devices 419-423 of the selected users. By way of example, the device 419 of a first contact Chance is labeled receiving device A, the device 421 of a second contact Kabir is labeled receiving device B and the device 423 of a second contact Mekail is labeled receiving device C. Under this scenario, receiving device A receives the advertisement 403 but no response action is taken on the part of Chance. Kabir receives and reviews the advertisement (e.g., selects the PLAY action button 405) and takes no further action. Mekail receives and reviews the advertisement as well. He also takes the further actions of purchasing products a number of products, such as by activating a BUY action button 409 via a touch screen interface of his television set. Still further, he decides to forward the advertisement 403 to ten other members of his social network, one of which includes Kabir.

Based on the above described actions, the influence scores of Kabir and Mekail are tabulated accordingly, while the influence score associated with Frank of user device 401 that is updated. Of note, the response types performed by Frank's contacts help increase his influence score. Also of note, the multitude of response types taken by Mekail versus that of Kabir results in a higher initial influence score being calculated for Mekail. The additional users to whom the advertisement 403 was forwarded may further increase Mekail and Frank's influence score. Still further, the influence scores of Frank and Mekail will be further increased based on the types of responses determined for Mekail's contacts, with the exception of Kabir who represents a common contact of Frank and Mekail. In this case, actions taken by Kabir count towards the influence score of Frank and not Mekail. Of note, this schema may be adapted at the discretion of the advertisement provider, i.e., enable a response by Kabir to count toward whichever person he responded to first.

In FIG. 4D, the user (Frank) of the forwarding device 401 is presented with a user interface for enabling review of their influence score 425. In addition, the user is presented with various statistics 427 for indicating the types of responses performed in association with the forwarded content. By way of example, the user is presented with data for indicating a number of points accumulated per friend. As noted above, for example, the number of points accumulated for Mekail is 12 while that of Kabir is 3 due to Mekail's increased level of response to the forwarded advertisement. Also presented are statistics for indicating the number of direct forwards initiated by the user of the forwarding device 401, the number of indirect forwards as initiated by any of the users of receiving devices 419-423, the number of buys performed by users of receiving devices 419-423 and the number of indirect buys for indicating subsequent purchases (e.g., by those within Mekail's social network).

While not shown expressly, the user may also customize the arrangement and type of data to be presented based on their preferences. Still further, in certain embodiments, the influence score may be updated in real time as various other recipients of the forwarded advertisement 403 respond accordingly.

FIG. 4E is a diagram of a user interface for enabling an advertisement provider to monitor the influence of a user that shares advertisement content with others, according to one embodiment. By way of example, the advertiser accesses a reporting interface 440 for viewing an influence score and associated statistics of a user for a given advertisement.

The user is presented with various action buttons, data entry fields and charts for enabling interaction of the advertiser with the advertisement sharing platform 103. This includes, for example, one or more links 441 for selecting a level of granularity of the report levels include a user view for reviewing data at the level of a single user, a global view for reviewing data at a broadly defined level, a group view for reviewing data for a defined group (e.g., males, sports enthusiasts, influence score above 50) and an area view for viewing data based on a defined geographic region (e.g., by zip code). Under this scenario, the advertiser selects a user view level of granularity 441 and indicates a specific user profile 443 to review. The user profile also presents an influence score of the selected user.

The interface 440 also presents various advertisement selection action buttons, e.g., 445, for indicating a specific advertisement to associate with the user. Upon selection of an advertisement, a data table 447 is presented for indicating various statistics of the user. By way of example, the data table 447 presents columns for indicating the various users to which the advertisement was forwarded (e.g., Kabir, Mekail), arranged by order of level of influence. Still further, the data table 447 includes various rows populated with data for indicating a response type and/or corresponding statistic related to a user to whom the advertisement was forwarded. For example, the rows may include the number of views performed by the user, the average time of viewing of the advertisement, a number of times the advertisement was forwarded, etc.

The interface 440 also presents various attributes 449 for defining one or more interests of the user 443. The interest data may be determined based on user profile information provided by the user. Alternatively, the user interests may be discerned based on the user's response to various advertisements. Moreover, the interface 440 presents key contacts of the user, i.e., based on those to whom the user frequently forwards advertisements.

The exemplary techniques and systems presented herein enable advertisement providers to access actionable data regarding the influence of a user over others within their social network. By associating an influence score with a user, the advertisement provider is able to quantify and target specific types of users for supporting a shared (word-of-mouth) marketing campaign. Also, users are able to determine the impact they have on peers within their social network for driving specific behaviors relative to an advertisement or any other content of interest to them.

The processes described herein for providing dynamic coupon sharing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

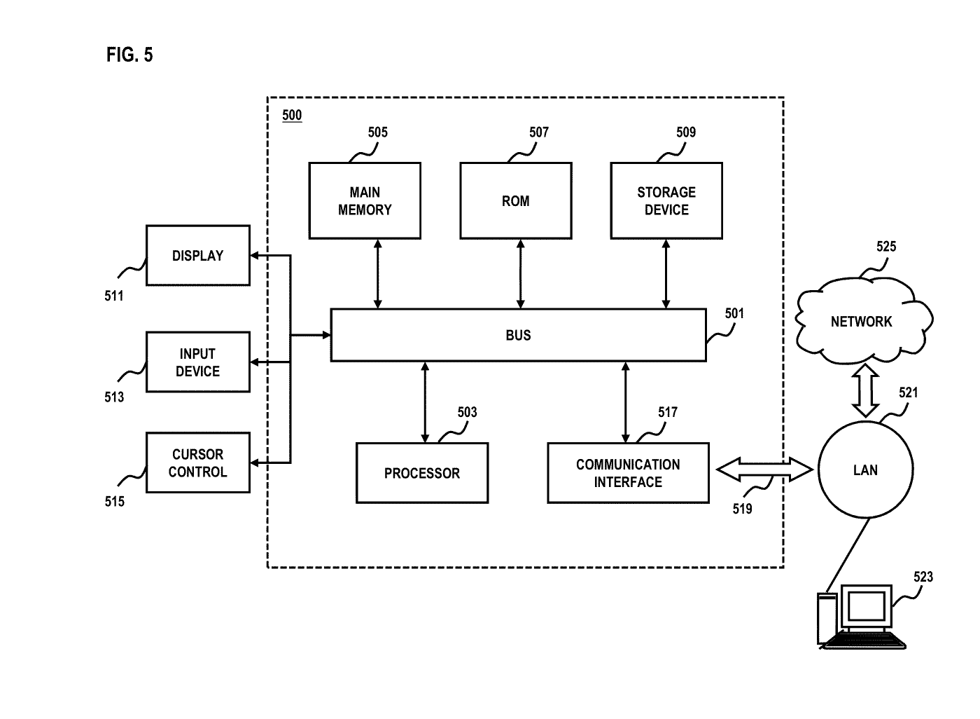

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIGS. 4A-4E, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

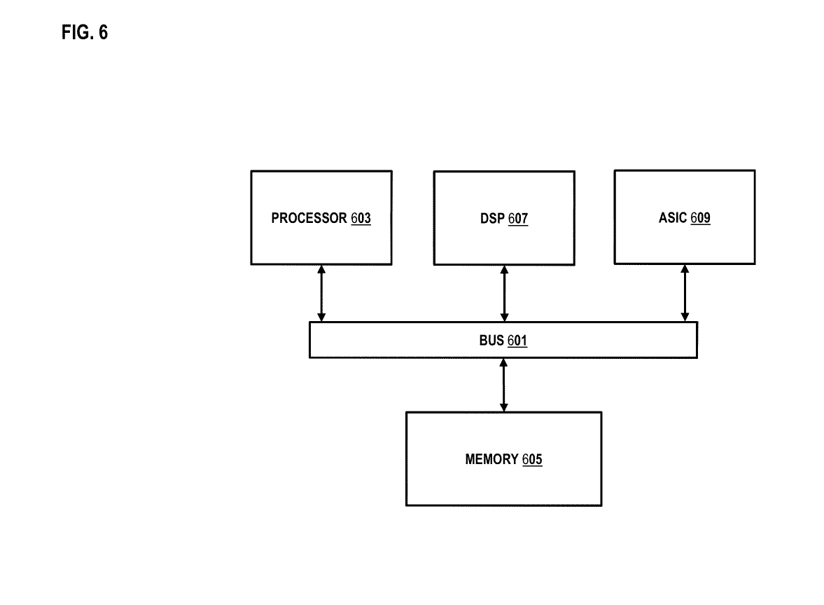

FIG. 6 illustrates a chip set or chip 600 upon which an embodiment of the invention may be implemented. Chip set 600 is programmed to score the influence of a user based on the sharing of an advertisement by the user with others as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of scoring the influence of a user based on the sharing of an advertisement by the user with others.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to score the influence of a user based on the sharing of an advertisement by the user with others. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
determining, by at least one processor, a forwarding of an advertisement by a first device to a second device associated with a social network of a user of the first device;
determining, based on a correlation of an input from the second device with one or more response criteria, a type of response of the user of the second device to the advertisement;
generating an influence score of the user of the first device and the user of the second device based on the type of response; and
initiating transfer of the influence score of the user of the first device and the user of the second device to a provider of the advertisement.

2. A method of claim 1, further comprising:
determining a forwarding of the advertisement by the user of the second device to a user of another device,
wherein the user of the other device is associated with a social network of the user of the second device.

3. A method of claim 2, further comprising:
calculating, based on a type of response of the user of the other device, an influence score of the user of the other device; and
initiating transfer of the influence score of the user of the other device via a network to a database maintained by a provider of the advertisement.

4. A method of claim 2, further comprising:
determining, based on social networking information, whether a correlation exists among the user of the other device, the user of the first device, and the user of the second device; and
updating an influence score of the user of the first device based on the determination of whether the correlation exists.

5. A method of claim 4, wherein the correlation is determined based on a common phone number, email address, network handle, user identifier, or a combination thereof.

6. A method of claim 1, further comprising:
generating a user interface for presenting the advertisement;
receiving, via the user interface, the input for specifying a response to the advertisement; and
correlating the input with the response criteria,
wherein the response criteria is defined by the provider of the advertisement.

7. A method of claim 6, wherein the input is transmitted via a user interface element presented via the user interface in association with the advertisement.

8. A method of claim 1, wherein the response criteria and the input are associated with either a purchase action, a forwarding action, a reviewing action, a bookmarking action, a storing action, a commenting action, a ranking action, an inquiry action of a user, or a combination thereof.

9. A method of claim 1, further comprising:
determining, based on the type of response, statistics associated with the advertisement, the user of the first device, the user of the second device or the user of the other device; and
generating, based on the statistics, a report for the provider of the advertisement.

10. A method of claim 1, wherein the influence score of a user is based on a number of viewers of the advertisement, a depth of connection of the viewers of the advertisement with the user, the type of response of the viewers of the advertisement, a size of the social network, a history of a user with the advertiser, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a forwarding of an advertisement by a first device to a second device associated with a social network of a user of the first device;
determine, based on a correlation of an input from the second device with one or more response criteria, a type of response of the user of the second device to the advertisement;
generate an influence score of the user of the first device and the user of the second device based on the type of response; and
initiate transfer of the influence score of the user of the first device and the user of the second device to a provider of the advertisement.

12. An apparatus of claim 11, further comprising:
determining a forwarding of the advertisement by the user of the second device to a user of another device,
wherein the user of the other device is associated with a social network of the user of the second device.

13. An apparatus of claim 12, further comprising:
calculating, based on a type of response of the user of the other device, an influence score of the user of the other device; and
initiating transfer of the influence score of the user of the other device via a network to a database maintained by a provider of the advertisement.

14. An apparatus of claim 12, further comprising:
determining, based on social networking information, whether a correlation exists among the user of the other device, the user of the first device, and the user of the second device; and
updating an influence score of the user of the first device based on the determination of whether the correlation exists.

15. An apparatus of claim 14, wherein the correlation is determined based on a common phone number, email address, network handle, user identifier, or a combination thereof.

16. An apparatus of claim 11, further comprising:
generating a user interface for presenting the advertisement;
receiving, via the user interface, the input for specifying a response to the advertisement; and
correlating the input with the response criteria,
wherein the response criteria is defined by the provider of the advertisement.

17. An apparatus of claim 16, wherein the input is transmitted via a user interface element presented via the user interface in association with the advertisement.

18. An apparatus of claim 11, wherein the response criteria and the input are associated with either a purchase action, a forwarding action, a reviewing action, a bookmarking action, a storing action, a commenting action, a ranking action, an inquiry action of a user, or a combination thereof.

19. An apparatus of claim 11, further comprising:
determining, based on the type of response, statistics associated with the advertisement, the user of the first device, the user of the second device or the user of the other device; and
generating, based on the statistics, a report for the provider of the advertisement.

20. An apparatus of claim 11, wherein the influence score of a user is based on a number of viewers of the advertisement, a depth of connection of the viewers of the advertisement with the user, the type of response of the viewers of the advertisement, a size of the social network, a history of a user with the advertiser, or a combination thereof.
